(19) United States
(12) Patent Application Publication
(10) Pub. No.: US 2013/0250349 A1
(43) Pub. Date: Sep. 26, 2013

(54) INFORMATION PROCESSING SYSTEM, NON-TRANSITORY COMPUTER READABLE MEDIUM STORING PROGRAM, AND INFORMATION PROCESSING METHOD

(71) Applicant: Jun NAKAMURA, Kanagawa (JP)

(72) Inventor: Jun NAKAMURA, Kanagawa (JP)

(73) Assignee: FUJI XEROX CO., LTD., Tokyo (JP)

(21) Appl. No.: 13/596,858

(22) Filed: Aug. 28, 2012

(30) Foreign Application Priority Data
Mar. 26, 2012 (JP) 2012-069125

(51) Int. Cl. G06F 3/12

(52) U.S. Cl. 358/1.15

(57) ABSTRACT

An information processing system includes one or plural processing units processing data and outputting the data to an output device, an allocation unit allocating data received from a client apparatus to the one processing unit or any one of the plural processing units, a storage unit storing the allocated data, a monitoring unit monitoring a status of the one processing unit or the plural processing units, and a unit increasing or decreasing the number of processing units on the basis of the status of the one processing unit or the plural processing units and a status of the stored data, wherein the processing unit stores the allocated data in the storage unit, and the one processing unit or any one of the plural processing units processes the data stored in the storage unit and outputs the processed data to the output device.

### CROSS-REFERENCE TO RELATED APPLICATIONS

This application is based on and claims priority under 35 USC 119 from Japanese Patent Application No. 2012-069125 filed Mar. 26, 2012.

### BACKGROUND

(i) Technical Field

The present invention relates to an information processing system, a non-transitory computer readable medium storing a program, and an information processing method.

(ii) Related Art

A system (cloud service) has been proposed in which a server that manages devices is provided on a network, such as the Internet (cloud), and through a client apparatus making a request, a process is caused to be executed on the device. In this type of cloud service, processing is performed by allocating resources to each service provided to the client apparatus.

When processing requests from the client apparatus increase or decrease, processing capability of the resources allocated to the client apparatus is likely to be insufficient or excessive. In contrast, in a case in which a print server stores a print request received from the client apparatus, processes data at the time when the data can be processed, and outputs the processed data to a printer, even when the allocation of the resources is dynamically changed, the process for the print request which has been received by the print server is not distributed. Therefore, there are cases where it is not possible to instantly obtain the effect due to the change in the allocation of the resources.

### SUMMARY

According to an aspect of the invention, there is provided an information processing system including: one or plural processing units that process data and output the processed data to an output device; an allocation unit that allocates data received from a client apparatus to the one processing unit or any one of plural processing units; a storage unit that stores the data which is allocated to the one processing unit or any one of plural processing units by the allocation unit; a monitoring unit that monitors a status of the one processing unit or plural processing units; and a unit that increases or decreases the number of processing units on the basis of the status of the one processing unit or plural processing units monitored by the monitoring unit and a status of the data stored in the storage unit, wherein the processing unit to which the data is allocated by the allocation unit stores the data in the storage unit, and the one processing unit or any one of plural processing units which can perform a process processes the data stored in the storage unit and outputs the processed data to the output device.

### BRIEF DESCRIPTION OF THE DRAWINGS

Exemplary embodiments of the present invention will be described in detail based on the following figures, wherein:

FIG. 1 is a system configuration diagram illustrating a cloud printing system according to a first exemplary embodiment;

FIG. 2 is a diagram illustrating an example of the structure of a shared database;

FIG. 3 is a diagram illustrating an example of an instance list table;

FIG. 4 is a diagram illustrating an example of an instance status management table;

FIG. 5 is a diagram illustrating an example of a print job status management table;

FIG. 6 is a diagram illustrating an example of standard data when it is determined whether to add an instance of the print server and whether to stop the use of the instance;

FIG. 7 is a diagram illustrating an example of standard data when an instance to be stopped is selected;

FIG. 8 is a sequence diagram illustrating a process when a print job is received;

FIG. 9 is a sequence diagram illustrating a control process of increasing or decreasing the number of instances of the print server;

FIG. 10 is a sequence diagram illustrating a process of updating the status information of a printer, which is a management target;

FIG. 11 is a sequence diagram illustrating a process of outputting a print job to the printer;

FIG. 12 is a system configuration diagram illustrating a printing system according to a second exemplary embodiment; and

FIG. 13 is a sequence diagram illustrating a process of outputting a print job to a printer.

### DETAILED DESCRIPTION

Hereinafter, exemplary embodiments of the invention will be described with reference to the accompanying drawings.

### 1. System Structure

### First Exemplary Embodiment

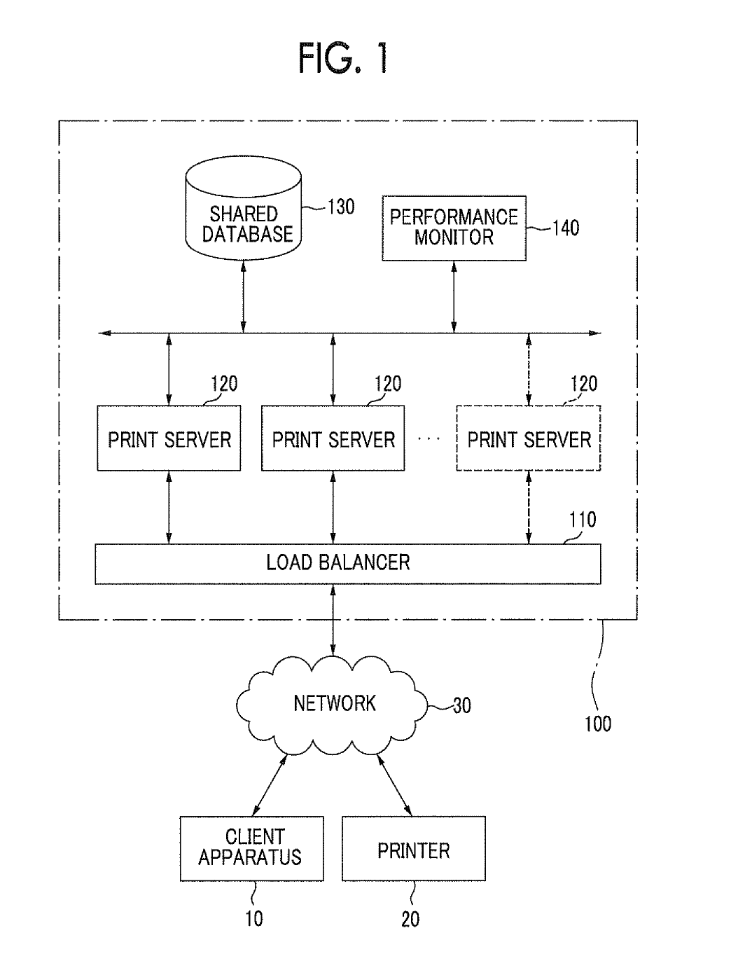

FIG. 1 is a system configuration diagram illustrating a cloud printing system 1 according to this exemplary embodiment. As shown in FIG. 1, the cloud printing system 1 includes a client apparatus 10, a printer 20, and a print management system 100. The client apparatus 10, the printer 20, and the print management system 100 are connected through a network 30, such as the Internet, so as to communicate with each other.

The client apparatus 10 is a computer, such as a personal computer, a mobile phone, a PDA, or a tablet terminal which is operated by the user.

The printer 20 is an apparatus which has a network function, communicates with the print management system 100 through the network 30, and performs an image forming process on the basis of data received from the print management system 100. A printer object (logical printer information) including the address and status of the printer 20 and information about a printer driver is registered in the print management system 100.

The print management system 100 provides a printing service to the client apparatus 10 through the network 30. For example, in this exemplary embodiment, the print management system 100 dynamically allocates the hardware resources of the print management system 100 to the printing service to construct the instances of the load balancer 110, the print server 120, the shared database 130, and the performance monitor 140. However, each instance may be constructed by each physical device.

The load balancer 110 has a function of receiving a processing request from the client apparatus 10 or the printer 20 through the network 30 and allocating the received processing request to any one of plural print servers 120.

The print server 120 has a function of receiving the processing request allocated from the load balancer 110 and performing a process based on the received processing request. For example, when a print job is received from the client apparatus 10, the print server 120 performs a process of registering the print job in the shared database 130, a process of determining whether the printer 20, which is an output destination, can output data, a process of generating data (print data) to be output to the printer 20, which is the output destination, and a process of transmitting the print data to the printer 20, which is the output destination. In addition, the print server 120 performs a process of writing its performance data to the shared database 130 at a predetermined time (for example, at a predetermined time interval).

The shared database 130 is a storage unit shared by the load balancer 110, the print server 120, and the performance monitor 140.

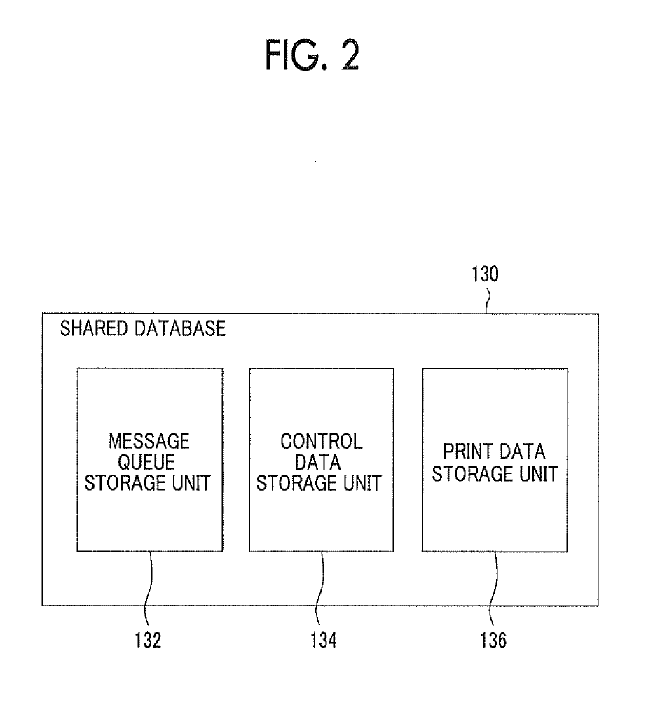

FIG. 2 shows an example of the structure of the shared database 130. As shown in FIG. 2, the shared database 130 includes a message queue storage unit 132, a control data storage unit 134, and a print data storage unit 136.

The message queue storage unit 132 stores a message queue shared by plural print servers 120. Each of the plural print servers 120 selects the next process to be performed from the message queue which is stored in the message queue storage unit 132 (for example, selects the next process in the order of registration of the message queue in the message queue storage unit 132) and performs the selected process. When the next process to be processed is generated by the process of each of the plural print servers 120, the plural print servers 120 may store the generated process in the message queue storage unit 132.

The control data storage unit 134 stores various kinds of control data, such as data indicating a list of the instances of the print server 120, data indicating the performances of the print server 120, data indicating the status of the received job, data indicating the status of the printer 20, and user data. Next, an example of the data stored in the control data storage unit 134 will be described.

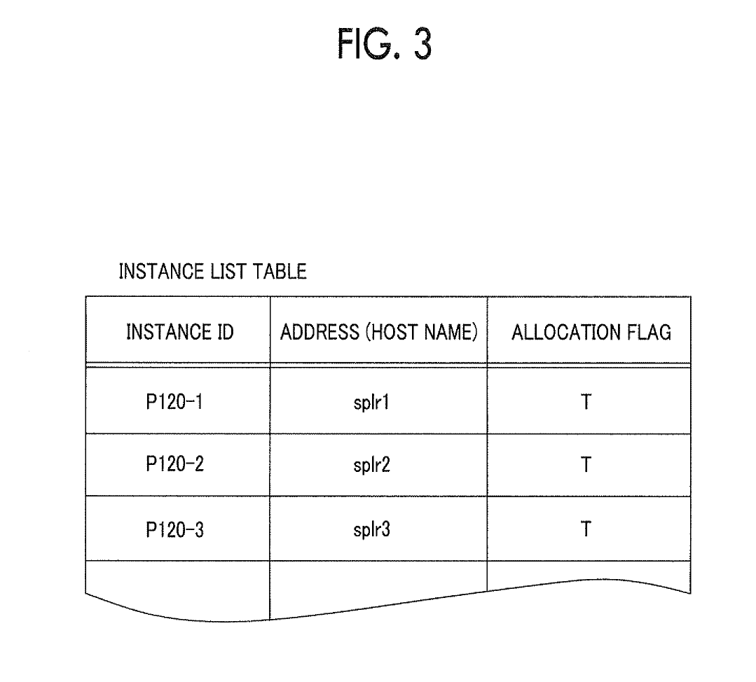

FIG. 3 shows an example of an instance list table stored in the control data storage unit 134. The instance list table stores a list of the instances of the print server 120 which are operating. The instance list table shown in FIG. 3 stores an instance ID for identifying the instance of the print server 120, the address (host name) of the instance of the print server 120, and an allocation flag (T indicates that allocation is available and F indicates that allocation is unavailable) indicating whether allocation is available so as to be associated with each other. For example, the load balancer 110 may randomly select one of the instance IDs with the allocation flag T (available) in the instance list table and allocate the pressing request to the selected address.

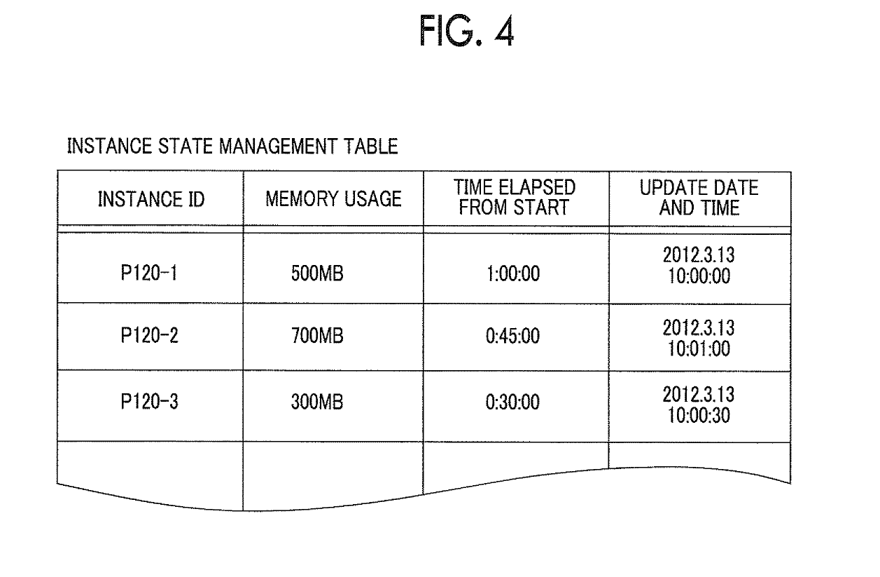

FIG. 4 shows an example of an instance status management table stored in the control data storage unit 134. The instance status management table stores the status of each instance of the print server 120. The instance status management table shown in FIG. 4 stores an instance ID for identifying the instance of the print server 120, the memory usage of the instance, the time elapsed from the start of the instance, and the information update date and time so as to be associated with each other. The instance status management table may be configured such that each instance of the print server 120 is periodically updated and the performance monitor 140 checks the status of each instance of the print server 120 and writes the check result to the instance status management table.

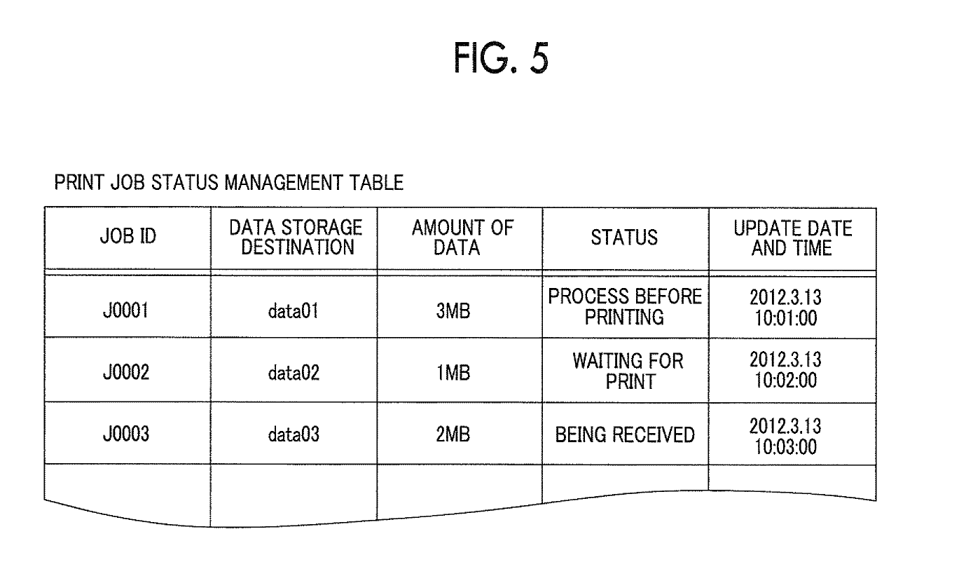

FIG. 5 shows an example of a print job status management table stored in the control data storage unit 134. The print job status management table stores information about each print job received by the print server 120. The print job status management table shown in FIG. 5 stores a job ID for identifying the print job, the storage destination of data which is received as a processing target of the print job, the amount of data to be processed, the status of the print job, and the information update date and time so as to be associated with each other. The print server 120 may receive a print job, add a record to the print job status management table for the received print job, perform a process for the print job, and update the status of the processed print job in the print job status management table. For example, the status of the print job may include “being received”, “waiting for print”, “process before printing”, “being printed”, and “completion”.

The print data storage unit 136 stores processing data related to the print job.

The performance monitor 140 acquires performance data for each or all of the instances of the print server 120 with reference to the shared database 130 and determines whether to add the instance of the print server 120 and whether to delete the instance of the print server 120, on the basis of the acquired performance data. For example, when processing capability is insufficient due to the instance of the print server 120 which is operating, the performance monitor 140 adds an instance of the print server 120. When the processing capability of the instances of the print server 120 which are operating is excessive, the performance monitor 140 selects an instance to be stopped from the instances of the print server 120 which are operating and stops and deletes the selected instance.

For example, the performance data acquired by the performance monitor 140 may include a queue length and a queue processing speed acquired from the message queue storage unit 132, the memory usage of each instance of the print server 120, the time elapsed from the start of the instance, the number of jobs (the number of jobs being received) with the status “being received” among the print jobs, the number of jobs (the number of jobs awaiting printing) with the status “waiting for print” among the print jobs, and the number of jobs (the number of jobs processed before printing) with the status “process before printing” among the print jobs which are acquired from the control data storage unit 134, and the amount of print data acquired from the print data storage unit 136.

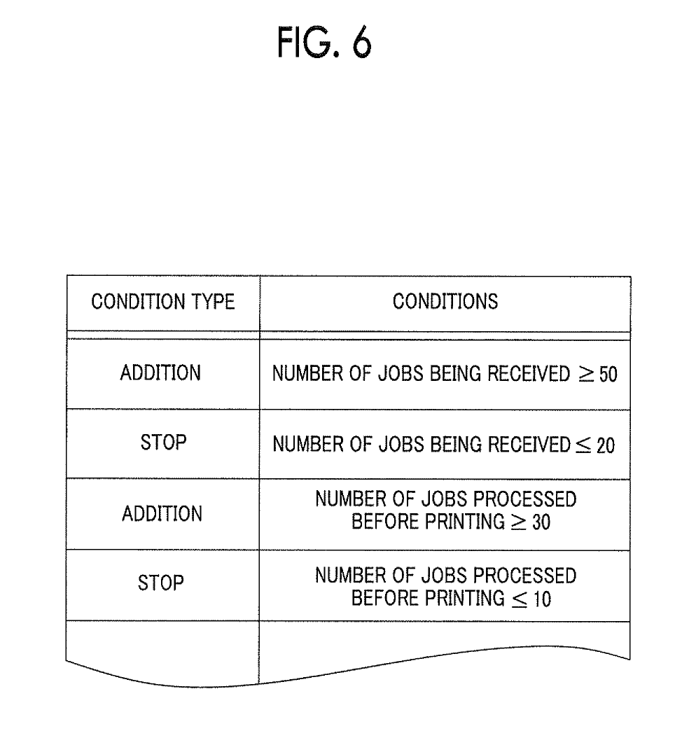

FIG. 6 shows an example of standard data when the performance monitor 140 determines whether to add the instance of the print server 120 and whether to stop the use of the instance. FIG. 6 shows a standard in which the instance of the print server 120 is added when the number of jobs being received among the print jobs received by the instance of the print server 120 is equal to or greater than (or greater than) an upper threshold value and the use of some of the instances of the print server 120 is stopped when the number of jobs being received is equal to or less than (or less than) a lower threshold value and a standard in which the instance of the print server 120 is added when the number of jobs processed before printing is equal to or greater than (or greater than) an upper threshold value and the use of some of the instances of the print server 120 is stopped when the number of jobs processed before printing is equal to or less than (or less than) a lower threshold value. However, other standards may be used. In addition, the number of jobs being received or the number of jobs processed before printing may be acquired with reference to the print job status management table stored in the shared database 130.

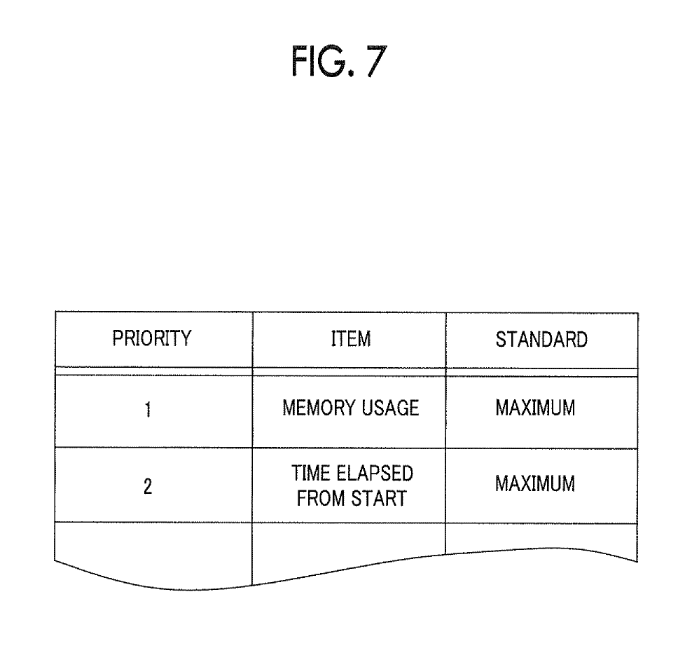

FIG. 7 shows an example of standard data when the performance monitor 140 determines the stop of the instances of the print server 120 and selects the instance to be stopped. FIG. 7 shows an example of a standard (priority 1) in which the instance with the maximum memory usage among the instances of the print server 120 is selected as the instance to be stopped and a standard (priority 2) in which the instance with the longest elapsed time from start is selected as the instance to be stopped. However, other standards may be used. When plural instances are selected in the standard with priority 1, the instance to be stopped may be selected in the standard with priority 2.

In addition, a computer including, for example, a control unit, such as a CPU, a storage unit, such as a memory, and an input/output unit that transmits and receives data to and from an external device may read a program stored in a computer-readable information storage medium and execute the program to implement the above-mentioned instances constructed by the print management system 100. The program may be provided to the computer by an information storage medium, such as an optical disc, a magnetic disk, a magnetic tape, a magneto-optical disc, or a flash memory, or it may be provided to the computer through a data communication network, such as the Internet.

### 2. Sequence

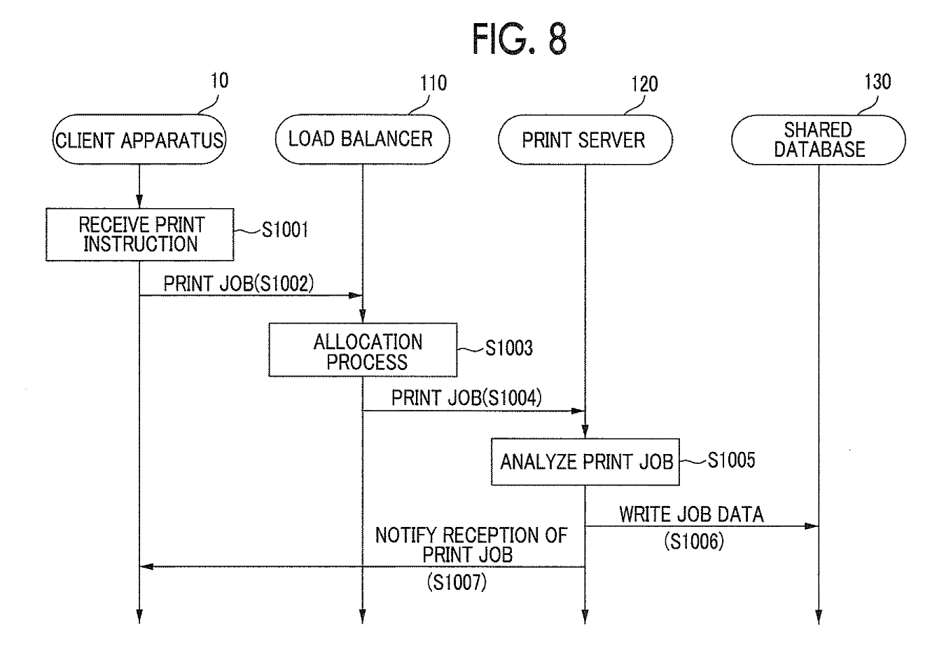

Next, an example of the sequence of the process performed in the first exemplary embodiment will be described with reference to FIGS. 8 to 11.

2.1. Process when Print Job is Received

FIG. 8 is a sequence diagram illustrating a process when the print job is received. As shown in FIG. 8, when receiving a print instruction from the user (S1001), the client apparatus 10 requests the print management system 100 to process the print job based on the received print instruction (transmits the print instruction to the load balancer 110) (S1002). In this exemplary embodiment, it is assumed that processing data and the printer 20, which is an output destination, are designated in the print instruction.

The load balancer 110 determines the instance to which the print job received from the client apparatus 10 will be allocated from the instances of the print server 120 which are operating in the instance list table (S1003) and transmits the print job to the determined instance of the print server 120 (S1004).

The instance of the print server 120 analyzes the print job allocated from the load balancer 110 (S1005) and writes processing data for the print job to the shared database 130 (S1006). For example, the instance of the print server 120 writes the status information of the print job to the print job status management table and stores the processing data of the print job in the print data storage unit 136.

Then, the instance of the print server 120 notifies the client apparatus 10 that the print job has been received (S1007).

The printing system may perform the above-mentioned process whenever the client apparatus 10 receives the print job.

### 2.2. Process of Increasing or Decreasing Number of Instances

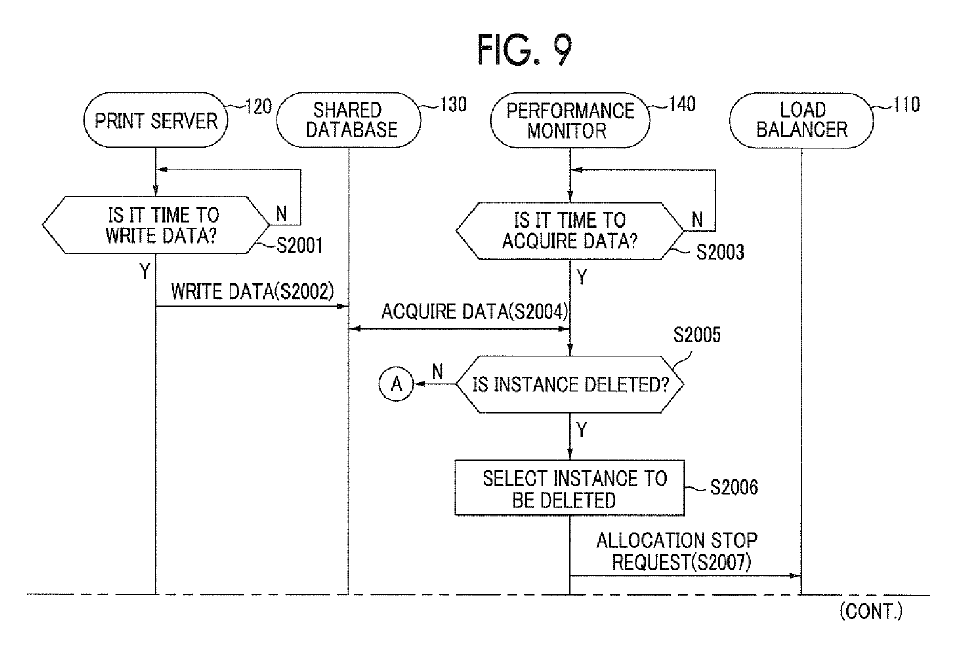

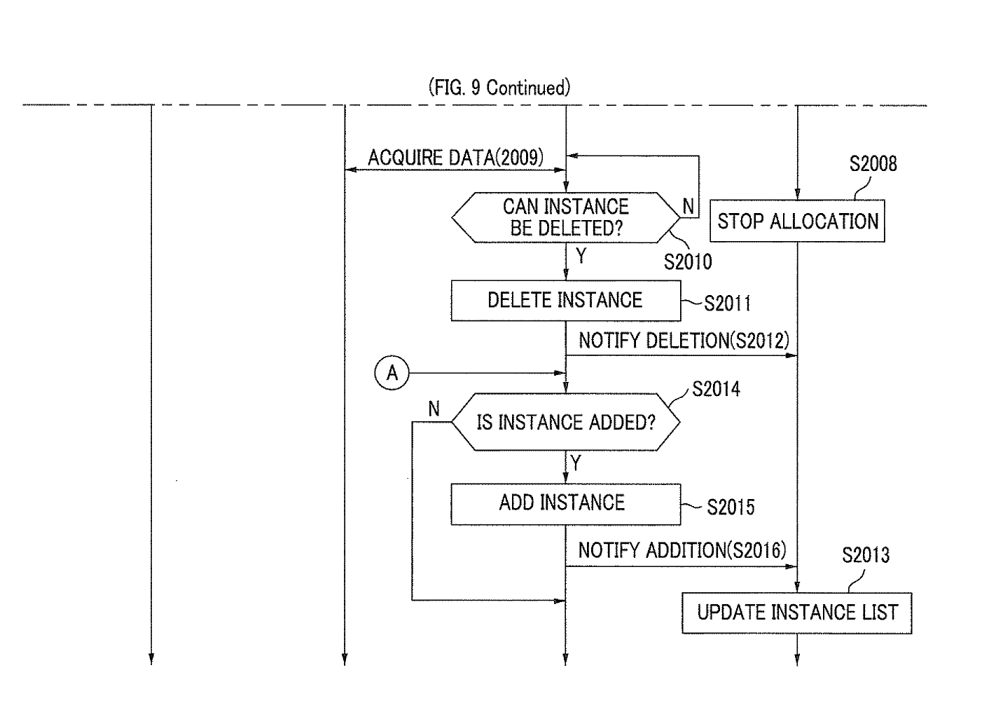

Next, a control process of increasing or decreasing the number of instances of the print server 120 will be described with reference to the sequence diagram shown in FIG. 9.

As shown in FIG. 9, each instance of the print server 120 determines whether it is time to write the performance data (for example, the performance data may be periodically written) (S2001). When it is determined that it is not time to write the performance data (S2001: N), the instance waits. When it is determined that it is time to write the performance data (S2001: Y), the instance writes the performance data to the shared database 130 (instance status management table) (S2002).

The performance monitor 140 determines whether it is time to acquire the performance data (for example, the performance data may be periodically acquired) (S2003). When it is determined that it is not time to acquire the performance data (S2003: N), the performance monitor 140 waits. When it is determined that it is time to acquire the performance data (S2003: Y), the performance monitor 140 acquires the performance data from the shared database 130 (S2004).

The performance monitor 140 determines whether to delete (stop) the instance of the print server 120 which is operating, on the basis of the acquired performance data (S2005). When it is determined that the instance is deleted (stopped) (S2005: Y), the performance monitor 140 selects the instance (deletion target instance) to be deleted from the instances which are operating (S2006). Then, the performance monitor 140 requests the load balancer 110 to stop the allocation of the process to the instance to be deleted (S2007).

The load balancer 110 updates the allocation flag stored in the instance list table to be unavailable (F) for a deletion target instance corresponding to an allocation stop request and stops the allocation of the process to the deletion target instance (S2008). The performance monitor 140 may update the allocation flag.

The performance monitor 140 acquires the status information of the deletion target instance from the shared database 130 (S2009) and determines whether the deletion target instance can be deleted (for example, all of the processes to be performed have been completed) on the basis of the acquired status information (S2010). When it is determined in S2010 that it is difficult to delete the deletion target instance (S2010: N), the performance monitor 140 returns to S2009. When it is determined that the deletion target instance can be deleted (S2010: Y), the performance monitor 140 deletes the deletion target instance (S2011) and notifies the load balancer 110 that the deletion target instance has been deleted (S2012).

The load balancer 110 deletes the notified deletion target instance from the instance list table and updates the list of the instances which are operating (S2013).

When it is determined in S2005 that it is difficult to delete the instance (S2005: N), the performance monitor 140 determines whether to add the instance to the instances of the print server 120 which are operating, on the basis of the performance data acquired in S2004 (S2014). When it is determined that the instance is added (S2014: Y), the performance monitor 140 newly adds the instance (S2015) and transmits information about the newly added instance (additional instance) to the load balancer 110 (S2016).

The load balancer 110 newly adds the notified additional instance to the instance list table and updates the instance list (S2013).

In this way, when the processing capability of the instances of the print server 120 is insufficient, the number of instances increases. When the processing capability of the instances of the print server 120 is excessive, the number of instances decreases.

### 2.3. Process of Updating Status of Printer 20

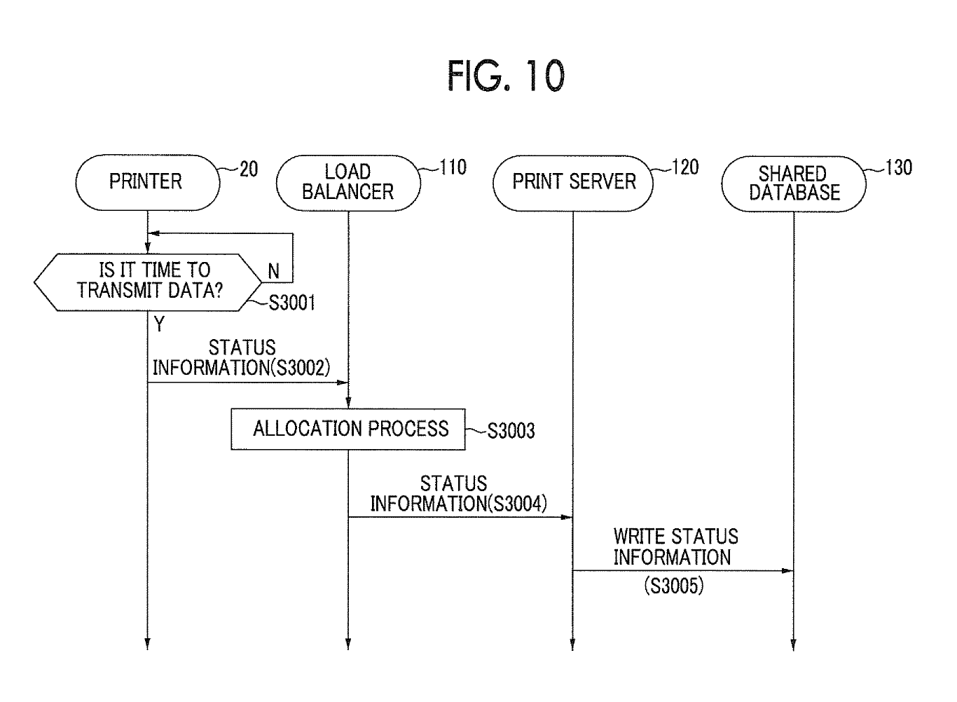

Next, a process of updating the status information of the printer 20, which is a management target, will be described with reference to the sequence diagram shown in FIG. 10.

As shown in FIG. 10, the printer 20, which is a management target, determines whether it is time to transmit status data (for example, the status data may be periodically transmitted) (S3001). When it is determined that it is not time to transmit the status data (S3001: N), the printer 20 waits. When it is determined that it is time to transmit the status data (S3001: Y), the printer 20 transmits the status data to the print management system 100 (load balancer 110) (S3002).

The load balancer 110 determines an instance to which a job for writing the status data received from the printer 20 will be allocated among the instances of the print server 120 which are operating in the instance list table (S3003) and transmits the status data to the determined instance of the print server 120 (S3004).

The instance of the print server 120 writes the status data allocated from the load balancer 110 to the shared database 130 (S3005).

In the printing system, the above-mentioned process may be performed whenever the status data is received from the printer 20.

### 2.4. Print Job Output Process

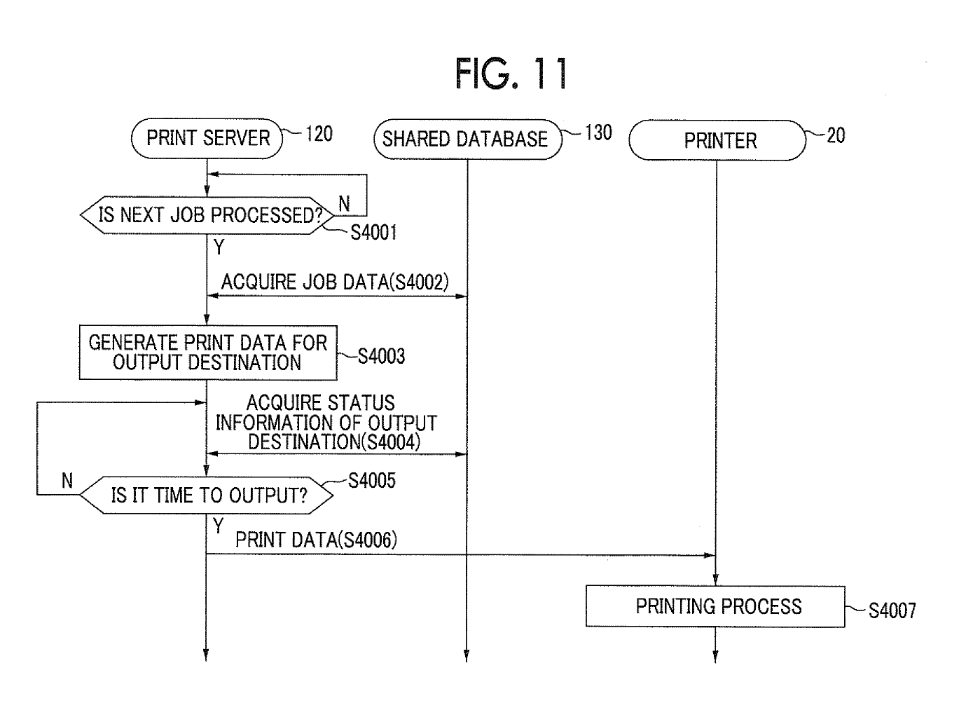

Next, a process of outputting the received print job to the printer 20 will be described with reference to the sequence diagram shown in FIG. 11.

As shown in FIG. 11, when the next job is processed (S4001: Y), the instance of the print server 120 acquires data for the print job indicated in the message queue stored in the message queue storage unit 132 from the print data storage unit 136 with reference to the message queue (S4002).

The instance of the print server 120 generates print data for an output destination on the basis of the acquired data for the print job and the data format which can be processed by the printer 20, which is an output destination (S4003).

The instance of the print server 120 acquires the status information of the printer 20, which is an output destination, from the shared database 130 (S4004) and determines whether the print data can be output on the basis of the acquired status information (S4005). When it is difficult to output the print data (S4005: N), the instance of the print server 120 waits. When the print data can be output (S4005: Y), the instance of the print server 120 transmits the print data generated in S4003 to the printer 20, which is an output destination (S4006).

The printer 20 receives the print data transmitted from the instance of the print server 120 and performs a printing process on the basis of the received print data (S4007). When the processing of the print data is completed, the instance of the print server 120 may delete the processing data of the print job from the print data storage unit 136.

This is an example of the sequence according to the first exemplary embodiment.

### 3. System Structure

### Second Exemplary Embodiment

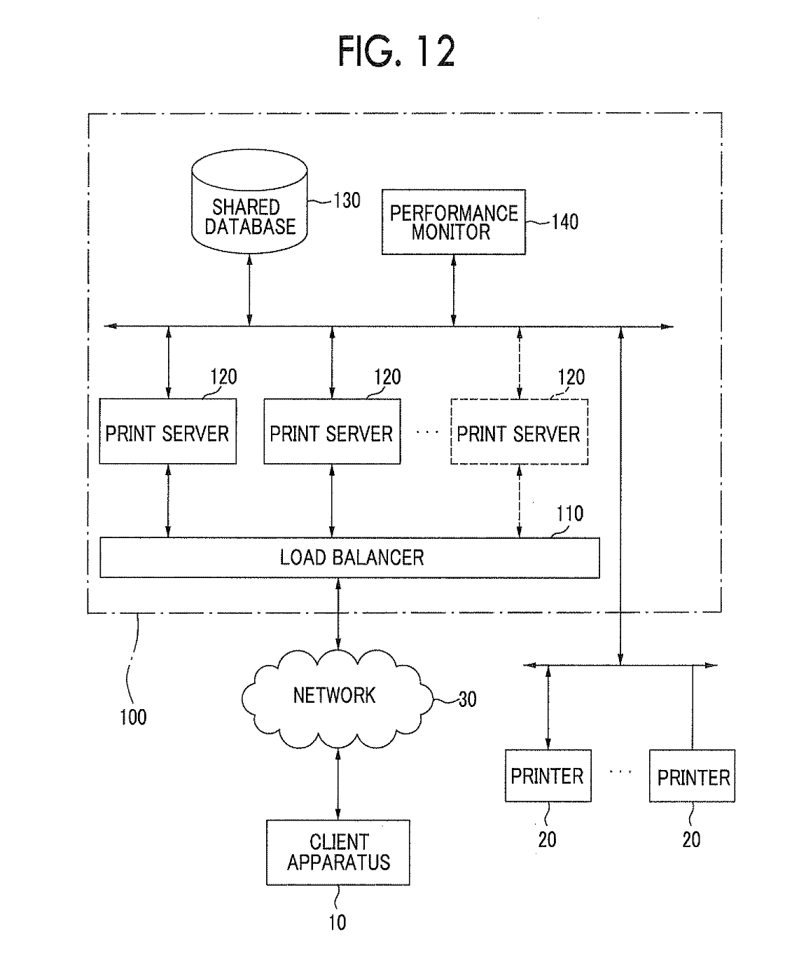

Next, a second exemplary embodiment will be described. FIG. 12 is a system configuration diagram illustrating a printing system according to the second exemplary embodiment. As shown in FIG. 12, the second exemplary embodiment differs from the first exemplary embodiment in that plural printers 20 are connected to the network 30 close to the print management system 100, but is similar to the first exemplary embodiment in the structure of the load balancer 110, the print server 120, the shared database 130, and the performance monitor 140. In addition, in the second exemplary embodiment, the client apparatus 10 does not designate the printer 20, which is an output destination, but any one of the plural printers 20 may output data.

In the second exemplary embodiment, a process when the print job shown in FIG. 8 is received and a control process of increasing or decreasing the number of instances of the print server 120 shown in FIG. 9 may be the same as those in the first exemplary embodiment. Next, processes different from those in the first exemplary embodiment will be described.

### 4.1. Print Job Output Process

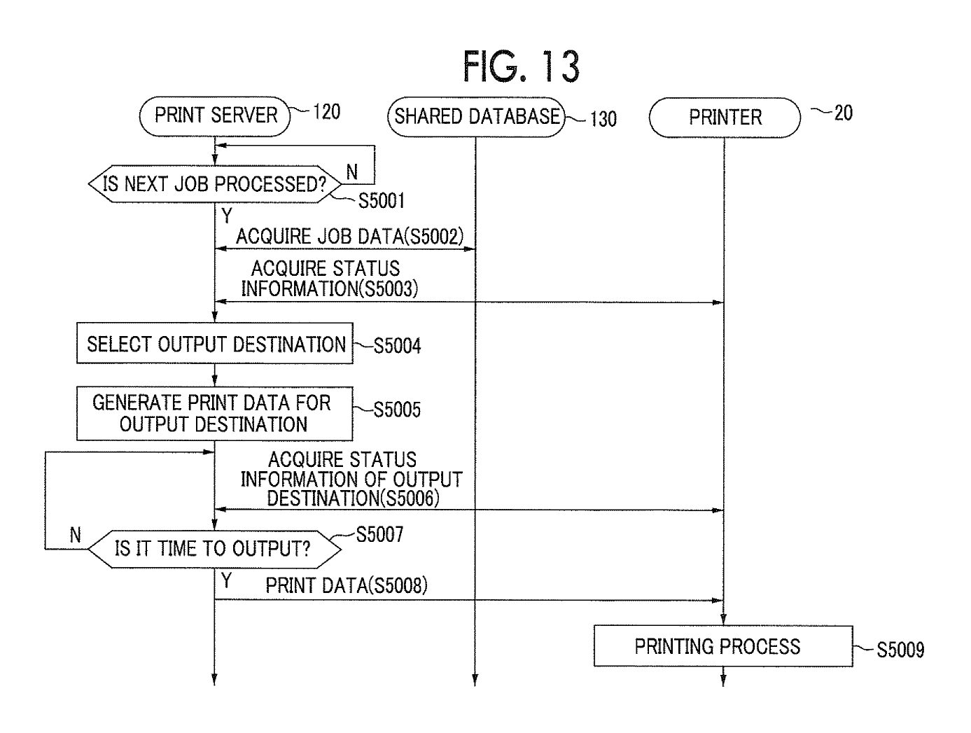

FIG. 13 shows the sequence of the process of outputting the received print job to the printer 20.

As shown in FIG. 13, when the next job is processed (S5001: Y), the instance of the print server 120 acquires data for the print job indicated in a message queue which is stored in the message queue storage unit 132 from the print data storage unit 136 with reference to the message queue (S5002).

The instance of the print server 120 acquires status information from each of the plural printers 20 (S5003) and selects a printer 20, which is an output destination, on the basis of the acquired status information (S5004). As the printer 20, which is an output destination, for example, the printer 20 with the smallest number of jobs spooled may be selected.

The instance of the print server 120 generates print data for an output destination on the basis of the acquired data for the print job and the data format which can be processed by the printer 20, which is an output destination (S5005).

The instance of the print server 120 acquires the status information of the printer 20, which is an output destination (S5006) and determines whether the print data can be output on the basis of the acquired status information (S5007). When it is difficult to output the print data (S5007: N), the instance of the print server 120 waits. When the print data can be output (S5007: Y), the instance of the print server 120 transmits the print data generated in S5005 to the printer 20, which is an output destination (S5008).

The printer 20 receives the print data transmitted from the instance of the print server 120 and performs a printing process on the basis of the received print data (S5009). When the processing of the print data is completed, the instance of the print server 120 may delete the processing data of the print job from the print data storage unit 136.

This is an example of the sequence according to the second exemplary embodiment.

The invention is not limited to the above-described exemplary embodiments. For example, in the above-described exemplary embodiment, the invention is applied to the processing of the print job. However, the invention may be similarly applied to a processing request other than the print job.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or a plurality of processing units that process data and output the processed data to an output device;
an allocation unit that allocates data received from a client apparatus to the one processing unit or any one of the plurality of processing units;
a storage unit that stores the data which is allocated to the one processing unit or any one of the plurality of processing units by the allocation unit;
a monitoring unit that monitors a status of the one processing unit or the plurality of processing units; and
a unit that increases or decreases the number of processing units on the basis of the status of the one processing unit or the plurality of processing units monitored by the monitoring unit and a status of the data stored in the storage unit,
wherein the processing unit to which the data is allocated by the allocation unit stores the data in the storage unit, and
the one processing unit or any one of the plurality of processing units which can perform a process processes the data stored in the storage unit and outputs the processed data to the output device.

2. The information processing system according to claim 1,
wherein, when the output device, which is an output destination of the data, can perform a process, the one processing unit or any one of the plurality of processing units which can perform a process processes the data stored in the storage unit and outputs the processed data to the output device.

3. The information processing system according to claim 1, further comprising:
a unit that monitors a status of a plurality of output devices; and
a selection unit that selects an output device, which is an output destination of the data, from the plurality of output devices on the basis of the status of each of the plurality of output devices,
wherein the one processing unit or any one of the plurality of processing units which can perform a process processes the data stored in the storage unit and outputs the processed data to the output device selected by the selection unit.

4. The information processing system according to claim 2, further comprising:
a unit that monitors a status of a plurality of output devices; and
a selection unit that selects an output device, which is an output destination of the data, from the plurality of output devices on the basis of the status of each of the plurality of output devices,
wherein the one processing unit or any one of the plurality of processing units which can perform a process processes the data stored in the storage unit and outputs the processed data to the output device selected by the selection unit.

5. The information processing system according to claim 1, further comprising:
a unit that determines the processing unit to be deleted among the one processing unit or the plurality of processing units when the unit that increases or decreases the number of processing units decreases the number of processing units; and
a unit that deletes the processing unit to be deleted after the allocation of the data to the processing unit to be deleted by the allocation unit is stopped.

6. The information processing system according to claim 2, further comprising:
a unit that determines the processing unit to be deleted among the one processing unit or the plurality of processing units when the unit that increases or decreases the number of processing units decreases the number of processing units; and
a unit that deletes the processing unit to be deleted after the allocation of the data to the processing unit to be deleted by the allocation unit is stopped.

7. The information processing system according to claim 3, further comprising:
a unit that determines the processing unit to be deleted among the one processing unit or the plurality of processing units when the unit that increases or decreases the number of processing units decreases the number of processing units; and
a unit that deletes the processing unit to be deleted after the allocation of the data to the processing unit to be deleted by the allocation unit is stopped.

8. The information processing system according to claim 4, further comprising:
a unit that determines the processing unit to be deleted among the one processing unit or the plurality of processing units when the unit that increases or decreases the number of processing units decreases the number of processing units; and
a unit that deletes the processing unit to be deleted after the allocation of the data to the processing unit to be deleted by the allocation unit is stopped.

9. A non-transitory computer readable medium storing a program that causes a computer to function as:
one or a plurality of processing units that process data and output the processed data to an output device;
an allocation unit that allocates data received from a client apparatus to the one processing unit or any one of the plurality of processing units;
a unit that stores the data which is allocated to the one processing unit or any one of the plurality of processing units by the allocation unit in a storage unit;
a monitoring unit that monitors a status of the one processing unit or the plurality of processing units; and
a unit that increases or decreases the number of processing units on the basis of the status of the one processing unit or the plurality of processing units monitored by the monitoring unit and a status of the data stored in the storage unit,
wherein the processing unit to which the data is allocated by the allocation unit stores the data in the storage unit, and
the one processing unit or any one of the plurality of processing units which can perform a process processes the data stored in the storage unit and outputs the processed data to the output device.

10. An information processing method comprising:
processing data and outputting the processed data to an output device by one or a plurality of processing units;
allocating data received from a client apparatus to the one processing unit or any one of the plurality of processing units by an allocation unit;
storing the data which is allocated to the one processing unit or any one of the plurality of processing units by the allocation unit in a storage unit;
monitoring a status of the one processing unit or the plurality of processing units by a monitoring unit; and
increasing or decreasing the number of processing units on the basis of the status of the one processing unit or the plurality of processing units monitored by the monitoring unit and a status of the data stored in the storage unit,
wherein the processing unit to which the data is allocated by the allocation unit stores the data in the storage unit, and
the one processing unit or any one of the plurality of processing units which can perform a process processes the data stored in the storage unit and outputs the processed data to the output device.
